(19) United States
(12) Patent Application Publication
(10) Pub. No.: US 2025/0211035 A1
(43) Pub. Date: Jun. 26, 2025

(54) MAGNETIC CORE AND METHOD FOR MANUFACTURING THE SAME, MAGNETIC CORE WITH COIL, AND ROTARY ELECTRIC MACHINE

(71) Applicant: Murata Manufacturing Co., Ltd., Nagaokakyo-shi (JP)

(72) Inventors: Satoshi HIROSUE, Nagaokakyo-shi (JP); Hisato AMANO, Nagaokakyo-shi (JP); Masashi UNO, Nagaokakyo-shi (JP); Kazuyoshi ISHIZUKA, Nagaokakyo-shi (JP); Ryosuke YAMAMOTO, Nagaokakyo-shi (JP)

(21) Appl. No.: 19/081,484

(22) Filed: Mar. 17, 2025

Related U.S. Application Data
(63) Continuation of application No. PCT/JP2024/026634, filed on Jul. 25, 2024.

(30) Foreign Application Priority Data
Aug. 25, 2023 (JP) 2023-136919

(51) Int. Cl. H02K 1/14; H02K 15/022

(52) U.S. Cl. CPC H02K 1/146; H02K 15/022

(57) ABSTRACT

A magnetic core that includes: a core back portion including a front surface that faces in a first direction toward a rotation axis of a rotary electric machine; and a tooth portion. The tooth portion includes a tooth main body portion extending from the front surface in the first direction, and a tooth leading end portion at a leading end of the tooth main body portion. The tooth leading end portion includes a back surface facing in a direction opposite to the first direction. The tooth main body portion includes an end surface that faces in a second direction along the rotation axis. The end surface includes a curved surface having a depressed shape and that is connected to the front surface of the core back portion or the back surface of the tooth leading end portion.

### CROSS REFERENCE TO RELATED APPLICATIONS

The present application is a continuation of International application No. PCT/JP2024/026634, filed Jul. 25, 2024, which claims priority to Japanese Patent Application No. 2023-136919, filed Aug. 25, 2023, the entire contents of each of which are incorporated herein by reference.

### TECHNICAL FIELD

The present disclosure relates to a technique for reducing occurrence of magnetic saturation in a rotary electric machine.

### BACKGROUND ART

As a rotary electric machine of the related art, for example, the motor described in Patent Document 1 has been known. The motor described in Patent Document 1 includes a stator and a rotor disposed inside the stator such that an axis of the stator and a rotation center coincide with each other. The stator includes a stator core and a stator coil wound around a plurality of teeth. The stator core is a powder compact magnetic core made of a powder containing particles of a magnetic material. The stator core is integrally molded by compacting the powder with a predetermined pressure using a molding die.

The stator core includes a yoke and the plurality of teeth. The yoke is formed in a cylindrical shape. Each tooth extends from an inner peripheral surface of the yoke toward an inside of the yoke. The plurality of teeth is formed on the inner peripheral surface of the yoke so as to be arranged at equal intervals in a circumferential direction. The stator coil is wound around each of the plurality of teeth.

The cylindrical yoke of the stator core is divided into a plurality of portions in the circumferential direction. The stator core includes a plurality of yoke pieces formed by division. Each yoke piece includes one tooth.

The tooth includes a tooth main body portion formed in a quadrangular prism shape extending from the inner peripheral surface of the yoke toward the inside of the yoke, and a tooth leading end portion located at a leading end of the tooth main body portion. The tooth is formed in a substantially T shape when viewed in an axial direction of the stator. The tooth faces the rotor. The stator coil is wound around the tooth main body portion.

Patent Document 1: Japanese Unexamined Patent Application Publication No. 2017-060395

### SUMMARY OF THE DISCLOSURE

In recent years, in order to increase output of an apparatus driven by a motor, there is a demand for improvement in output torque of the motor. In order to improve the output torque of a motor including a stator core having the above-described configuration, it is necessary to increase a magnetic flux generated by energization of the stator coil. The magnetic flux flows in the stator core.

On the other hand, in particular, in a small-sized motor, the stator core is reduced in size, and thus magnetic saturation is likely to occur in the stator core. When magnetic saturation occurs in the stator core, the magnetic flux flowing in the stator core cannot be increased, and this limits the improving of the output torque of the motor.

Accordingly, an object of the present disclosure is to provide a magnetic core and a method for manufacturing the magnetic core, a magnetic core with a coil, and a rotary electric machine that allow occurrence of magnetic saturation to be reduced.

A magnetic core according to an aspect of the present disclosure is used in a rotary electric machine. The magnetic core includes: a core back portion including a front surface that faces in a first direction toward a rotation axis of the rotary electric machine when the magnetic core is incorporated in the rotary electric machine; a tooth portion, wherein the tooth portion includes: a tooth main body portion extending from the front surface in the first direction, and a tooth leading end portion at a leading end of the tooth main body portion, wherein the tooth leading end portion includes a back surface facing in a direction opposite to the first direction, the tooth main body portion includes an end surface that faces in a second direction along the rotation axis when the magnetic core is incorporated in the rotary electric machine; and a first curved surface forming portion that is a part of the end surface of the tooth main body portion, the first curved surface forming portion including a curved surface having a depressed shape and that is connected to the front surface of the core back portion or the back surface of the tooth leading end portion.

In the related art, a flat end surface of a tooth main body portion and a flat front surface of a core back portion or a flat back surface of a tooth leading end portion are connected to each other. In this case, a corner is formed in a portion where the end surface of the tooth main body portion and the front surface of the core back portion or the back surface of the tooth leading end portion are connected to each other. When the magnetic core is incorporated in a rotary electric machine, energization of a coil wound around the tooth main body portion generates a magnetic flux in the magnetic core through the tooth main body portion. A direction of the magnetic flux is a direction from the tooth main body portion toward the front surface of the core back portion or the back surface of the tooth leading end portion. At this time, a flow of the magnetic flux tends to take a shortest route inside the magnetic core. In the related art, since the corner is formed in the portion where the end surface of the tooth main body portion and the front surface of the core back portion or the back surface of the tooth leading end portion are connected to each other, the corner disturbs the flow of the magnetic flux that tends to flow in the shortest route, magnetic resistance in a magnetic circuit increases near the corner, and the magnetic flux does not easily flow near the corner. Consequently, magnetic saturation locally occurs in the corner portion.

On the other hand, in the above-described magnetic core, the end surface of the tooth main body portion includes the curved surface having a depressed shape and smoothly connected to the front surface of the core back portion or the back surface of the tooth leading end portion, and the curved surface is formed by the first curved surface forming portion that is a part of the tooth main body portion. Therefore, in the first direction, a corner as in the related art is not formed in the above-described magnetic core, and the magnetic flux can pass through the first curved surface forming portion and flow in a short route. This leads to a reduction in magnetic resistance in the magnetic circuit. As a result, the occurrence of local magnetic saturation can be reduced. In addition, in the core back portion or the tooth leading end portion, in a direction orthogonal to the first direction, a region in which the magnetic flux flows can be increased. Therefore, the core back portion can be effectively utilized as a magnetic circuit. As a result, the output torque of the rotary electric machine including the magnetic core can be further improved.

In the above-described magnetic core, the end surface of the tooth main body portion may include a first flat surface parallel to the first direction, and the first curved surface forming portion may project from the first flat surface in the second direction and may be located only on the second direction side from the first flat surface.

In the above-described configuration, in the second direction, the first curved surface forming portion is formed without reducing a cross-sectional area of the tooth main body portion. Therefore, the formation of the first curved surface forming portion does not lower a saturated magnetic flux density of the magnetic flux flowing inside the tooth main body portion. As a result, a reduction in output torque of the rotary electric machine can be suppressed.

In the above-described magnetic core, the tooth main body portion may include a side surface that faces in a circumferential direction with the rotation axis of the rotary electric machine as a center when the magnetic core is incorporated in the rotary electric machine. In this configuration, the side surface includes a curved surface having a depressed shape and smoothly connected to the front surface of the core back portion or the back surface of the tooth leading end portion, and the curved surface is formed by a second curved surface forming portion that is a part of the tooth main body portion.

In the above-described configuration, in the circumferential direction, a corner as in the related art is not formed, and the magnetic flux can pass through the second curved surface forming portion and flow in a short route. This leads to a reduction in magnetic resistance in the magnetic circuit. As a result, the occurrence of local magnetic saturation can be reduced.

In the above-described magnetic core, the side surface may include a second flat surface parallel to the first direction, and the second curved surface forming portion may project from the second flat surface in the circumferential direction and may be located only on the circumferential direction side from the second flat surface.

In the above-described configuration, in the circumferential direction, the second curved surface forming portion is formed without reducing the cross-sectional area of the tooth main body portion. Therefore, the formation of the second curved surface forming portion does not lower the saturated magnetic flux density of the magnetic flux flowing inside the tooth main body portion. As a result, a reduction in output torque of the rotary electric machine can be suppressed.

In the above-described magnetic core, the tooth main body portion may include a side surface facing in a third direction that is a circumferential direction with the rotation axis as a center when the magnetic core is incorporated in the rotary electric machine and an inclined surface connecting the end surface and the side surface. In this configuration, the inclined surface includes a tapered and curved surface smoothly connected to an edge of the curved surface of the end surface in the third direction, and the tapered and curved surface is formed by a third curved surface forming portion that is a part of the tooth main body portion.

In the above-described configuration, on the core back portion side of the tooth main body portion, a corner is not formed in a portion where the end surface and the side surface of the tooth main body portion are connected to each other, and the magnetic flux easily flows. As a result, the occurrence of local magnetic saturation can be further reduced.

The above-described magnetic core may be a molded body formed from a soft magnetic powder.

In the above-described configuration, the magnetic core can be easily manufactured.

A method for manufacturing a magnetic core according to an aspect of the present disclosure includes a finishing step of finishing the above-described magnetic core through polishing using a spherical medium, and before the finishing step, the magnetic core is manufactured such that a radius of curvature of the curved surface included in the end surface is already larger than a radius of the medium used in the finishing step.

In the above-described manufacturing method, since the radius of curvature of a first curved surface is larger than the radius of the medium, in the finishing step, the medium can come into contact with the entire curved surface of the end surface of the tooth main body portion, and burrs formed on the curved surface of the end surface of the tooth main body portion before the finishing step can be removed in the finishing step. As a result, when the coil is wound around the tooth main body portion after the magnetic core is completed, damage to the coil can be suppressed. In addition, after the finishing step, when an insulating film is applied to a surface of the magnetic core, the insulating film can be made thin, a slot fill factor of the coil can be increased, and output efficiency of the rotary electric machine can be improved.

A method for manufacturing a magnetic core according to an aspect of the present disclosure includes a finishing step of finishing the above-described magnetic core through polishing using a spherical medium, and before the finishing step, the magnetic core is manufactured such that a radius of curvature of the curved surface included in the side surface is already larger than a radius of the medium used in the finishing step.

In the above-described manufacturing method, since a minimum value of the radius of curvature of a second curved surface is larger than the radius of the medium, in the finishing step, the medium can come into contact with the entire curved surface of the side surface of the tooth main body portion, and burrs formed on the curved surface of the side surface of the tooth main body portion before the finishing step can be removed in the finishing step. As a result, when the coil is wound around the tooth main body portion after the magnetic core is completed, damage to the coil can be suppressed. In addition, after the finishing step, when an insulating film is applied to a surface of the magnetic core, the insulating film can be made thin, the slot fill factor of the coil can be increased, and the output efficiency of the rotary electric machine can be improved.

According to the present disclosure, the occurrence of magnetic saturation can be reduced.

### BRIEF DESCRIPTION OF THE DRAWINGS

FIG. 1 is an external perspective view of a brushless motor 100 in which a magnetic core 1 is used.

FIG. 2 is a partially cutaway perspective schematic view illustrating the brushless motor 100.

FIG. 3 is a perspective view of the magnetic core 1.

FIG. 4 includes a sectional view of the magnetic core 1 and an enlarged sectional view of a portion near a first curved surface forming portion R11.

FIG. 5 is a sectional view illustrating a magnetic flux flowing in a magnetic core 50 according to a comparative example in a motor including the magnetic core 50 according to the comparative example.

FIG. 6 is a sectional view illustrating a magnetic flux flowing in the magnetic core 1 in the brushless motor 100.

FIG. 7 is a sectional view illustrating a magnetic flux flowing in two magnetic cores 1 adjacent to each other in the brushless motor 100.

FIG. 8 is a sectional view illustrating an example of a process of manufacturing the magnetic core 1.

FIG. 9 illustrates a relationship between a radius of curvature CR1 of a first curved surface CS1 and a radius RA of a medium M.

FIG. 10 is a sectional view illustrating an inside of a barrel B in a finishing step.

FIG. 11 is a perspective view of a magnetic core 1a.

FIG. 12 is a perspective view of a magnetic core 1b.

FIG. 13 includes a sectional view of the magnetic core 1b and an enlarged sectional view of a portion near a second curved surface forming portion R21.

FIG. 14 illustrates a relationship between a radius of curvature CR2 of a second curved surface CS2 and the radius RA of the medium M.

### DESCRIPTION OF THE PREFERRED EMBODIMENTS

### First Embodiment

### Configuration of Brushless Motor 100

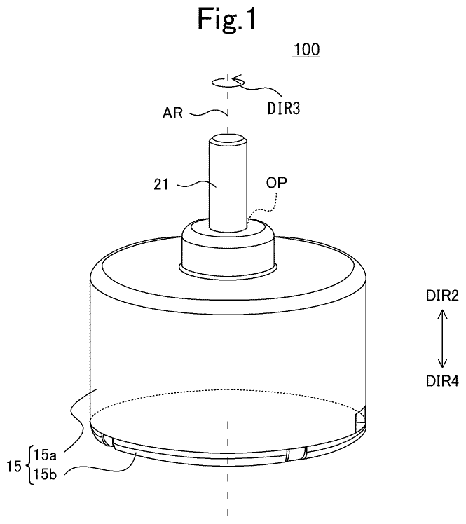

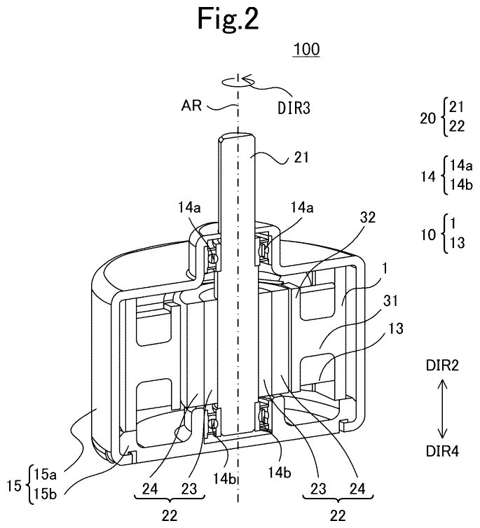

First, hereinafter, a configuration of a brushless motor 100 according to a first embodiment of the present disclosure will be described with reference to the drawings. FIG. 1 is an external perspective view of the brushless motor 100. FIG. 2 is a partially cutaway perspective schematic view illustrating the brushless motor 100.

In the specification, as an example, directions are defined as below. In a radial direction with a rotation axis AR of the brushless motor 100 as a center, a first direction DIR1 is defined as a direction from a tooth leading end portion 32 toward the rotation axis AR of the brushless motor 100. The first direction DIR1 is a direction toward the rotation axis AR of the brushless motor 100 when a magnetic core 1 is incorporated in the brushless motor 100. In an axial direction along the rotation axis AR of the brushless motor 100, a second direction DIR2 is defined as a direction in which a shaft 21 projects to an outside of a housing 15 from an opening OP. In a circumferential direction with the rotation axis AR of the brushless motor 100 as the center, a third direction DIR3 is defined as a clockwise direction with respect to the rotation axis AR of the brushless motor 100 as viewed in the second direction DIR2. A fourth direction DIR4 is defined as a direction opposite to the second direction DIR2.

As illustrated in FIG. 2, the brushless motor 100 includes a rotor 20, a stator 10, a bearing 14, and the housing 15. In the present embodiment, the brushless motor 100 is an inner-rotor brushless motor. That is, the stator 10 is disposed around the rotor 20. The brushless motor 100 is an example of a rotary electric machine of the present disclosure. Alternatively, the brushless motor 100 may be an outer-rotor brushless motor. That is, the rotor 20 may be disposed around the stator 10.

The rotary electric machine may have a structure in which a rotor is rotated by electricity. Alternatively, the rotary electric machine may have a structure in which the rotation of the rotor generates electricity. Examples of the rotary electric machine include a brushless motor, a permanent magnet synchronous motor, and a permanent magnet synchronous generator.

The rotor 20 includes the shaft 21 and a rotor member 22. The shaft 21 has a columnar shape. The rotor member 22 has a cylindrical shape. Central axes of the shaft 21 and the rotor member 22 coincide with each other and form the rotation axis AR.

The rotor member 22 includes a soft magnetic body 23 and a hard magnetic body 24. The rotor member 22 is attached to an outer peripheral surface of the shaft 21 in the radial direction with the rotation axis AR as the center. More specifically, the soft magnetic body 23 is attached to the outer peripheral surface of the shaft 21 in the radial direction with the rotation axis AR as the center. The hard magnetic body 24 is attached to an outer peripheral surface of the soft magnetic body 23 in the radial direction with the rotation axis AR as the center.

The hard magnetic body 24 is a hard magnetic body that is magnetized. The hard magnetic body is magnetized when a magnetic field is applied from an outside. Thereafter, even after the application of the magnetic field is stopped, the hard magnetic body stays magnetized.

The bearing 14 supports the shaft 21 such that the shaft 21 can rotate in the circumferential direction with the rotation axis AR as the center. More specifically, the bearing 14 includes a first bearing 14a and a second bearing 14b. In the present embodiment, each of the first bearing 14a and the second bearing 14b is a ball bearing. Each of the first bearing 14a and the second bearing 14b has a cylindrical shape extending along the rotation axis AR. A central axis of each of the first bearing 14a and the second bearing 14b is the rotation axis AR. That is, the central axis of each of the first bearing 14a and the second bearing 14b coincides with the central axis of the shaft 21. Each of the first bearing 14a and the second bearing 14b is not limited to a ball bearing.

The second bearing 14b is located further in the fourth direction DIR4 than is the first bearing 14a. In addition, the first bearing 14a is located further in the second direction DIR2 than is the rotor member 22. The second bearing 14b is located further in the fourth direction DIR4 than is the rotor member 22. The second bearing 14b supports an end of the shaft 21 in the fourth direction DIR4.

The stator 10 includes a coil 13 and the magnetic core 1. That is, in the present embodiment, the magnetic core 1 is used in the stator 10. A magnetic core according to the present disclosure may be used as a part of a rotor.

As illustrated in FIG. 1, the housing 15 includes a first housing 15a and a second housing 15b. As illustrated in FIGS. 1 and 2, the first housing 15a has a cylindrical shape. A central axis of the first housing 15a is the rotation axis AR. The first housing 15a is located further in the second direction DIR2 than is the second housing 15b. In addition, the first housing 15a includes the opening OP. The shaft 21 projects from the opening OP in the second direction DIR2. That is, in the present embodiment, the brushless motor 100 is a single-axis motor. The brushless motor 100 is not limited to a single-axis motor and may be a double-axis motor.

The first housing 15a supports the first bearing 14a, a plurality of the magnetic cores 1, and a plurality of coils 13. The second housing 15b supports the second bearing 14b. In the present embodiment, a material for each of the first housing 15a and the second housing 15b is stainless used steel (SUS). The material for each of the first housing 15a and the second housing 15b is not limited to stainless used steel (SUS) and may be another material as long as the material has high rigidity.

In the present embodiment, the number of coils 13 and the number of magnetic cores 1 are both nine. In FIG. 2, among the nine magnetic cores 1 and the nine coils 13, only the representative magnetic core 1 and the representative coil 13 are denoted by the reference numerals. Each of the nine coils 13 and the nine magnetic cores 1 is arranged in the circumferential direction with the rotation axis AR as the center. The nine magnetic cores 1 are arranged around the hard magnetic body 24 at an interval from the hard magnetic body 24. The number of coils 13 and the number of magnetic cores 1 are not limited to nine.

Each coil 13 is manufactured from a conductive material such as copper, for example. In addition, the coil 13 has a structure in which a surface of a copper wire is covered with an insulating coating film. Since the coil 13 has a structure in which the surface of the copper wire is covered with the insulating coating film, the coil 13 and the magnetic core 1 are electrically insulated from each other. However, in two terminal portions of the coil 13, the surface of the copper wire is not covered with the insulating coating film, and the copper wire is exposed.

The coil 13 is supplied with a current from a power source (not illustrated). When a current flows in the coil 13, the coil 13 generates a magnetic field. The magnetic core 1 is magnetized by each of a magnetic field generated by the hard magnetic body 24 and the magnetic field generated by the coil 13. Rotation of the rotor 20 is controlled through control of the current supplied from the power source (not illustrated).

### Configuration of Magnetic Core 1

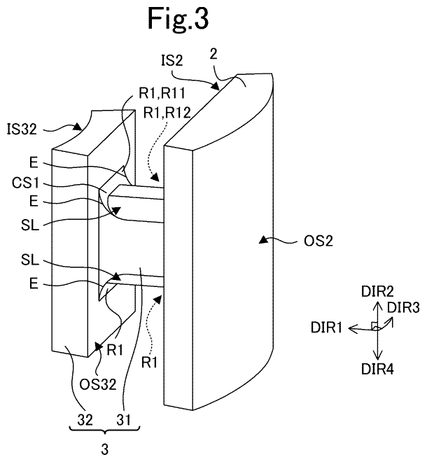

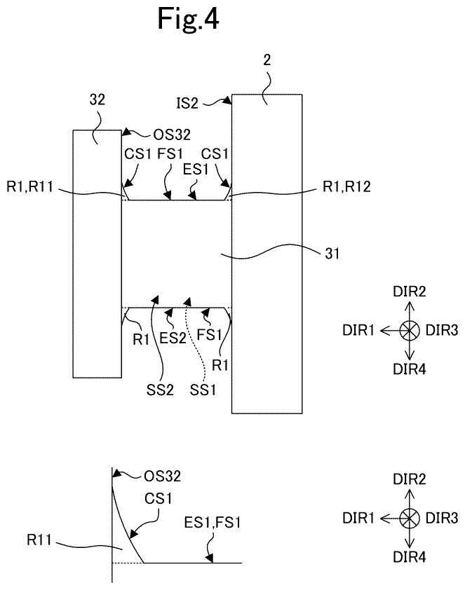

Hereinafter, a configuration of the magnetic core 1 according to the first embodiment of the present disclosure will be described with reference to the drawings. FIG. 3 is a perspective view of the magnetic core 1. FIG. 4 includes a sectional view of the magnetic core 1 and an enlarged sectional view of a portion near a first curved surface forming portion R11. In FIG. 3, among four inclined surfaces SL, only the representative inclined surfaces SL are denoted by the reference numeral. A cross section of the magnetic core 1 in FIG. 4 is taken in a plane passing through a first flat surface FS1 of a first end surface ES1 of a tooth main body portion 31 and orthogonal to the first flat surface FS1 of the first end surface ES1 of the tooth main body portion 31.

As illustrated in FIG. 3, the magnetic core 1 includes a core back portion 2 and a tooth portion 3. The core back portion 2 and the tooth portion 3 are included in the magnetic core 1, which is a single member. Here, the single member refers to a member having a structure that cannot be separated without being broken.

The magnetic core 1 is a soft magnetic body. In the present embodiment, the magnetic core 1 is a molded body formed from a soft magnetic powder. That is, each of the core back portion 2 and the tooth portion 3 is a molded body formed from a soft magnetic powder. A material of the soft magnetic powder contains, for example, iron and a binder. The binder is, for example, a resin. The soft magnetic powder is, for example, a mixture of an iron powder and an epoxy resin powder, which is an example of the binder powder. The above-described magnetic core 1 is manufactured by, for example, compaction molding. In addition, an insulating film (not illustrated) is applied to a surface of the magnetic core 1 that comes into contact with another member. The magnetic core 1 does not have to be a molded body formed from a soft magnetic powder.

The core back portion 2 includes a front surface IS2 facing in the first direction DIR1, a back surface OS2 facing in a direction opposite to the first direction DIR1, two side surfaces connecting the front surface IS2 and the back surface OS2 and arranged in the third direction DIR3, and two end surfaces connecting the front surface IS2 and the back surface OS2 and arranged in the second direction DIR2. In the present embodiment, each of the front surface IS2, the two side surfaces arranged in the third direction DIR3, and the two end surfaces arranged in the second direction DIR2 is a flat surface. The back surface OS2 is a curved surface curved in a projecting shape in the direction opposite to the first direction DIR1. The back surface OS2 forms a part of an outer peripheral surface of the stator 10. When the magnetic core 1 is incorporated in the brushless motor 100, each of the side surfaces connecting the front surface IS2 and the back surface OS2 is magnetically coupled to the side surface connecting the front surface IS2 and the back surface OS2 of the next magnetic core 1. Each of the front surface IS2, the two side surfaces arranged in the third direction DIR3, and the two end surfaces arranged in the second direction DIR2 may include a curved surface at least in a part thereof. In addition, the back surface OS2 may include a plane at least in a part thereof.

The tooth portion 3 has a shape extending from the core back portion 2 in the first direction DIR1. More specifically, the tooth portion 3 includes the tooth main body portion 31 extending from the front surface IS2 in the first direction DIR1 and the tooth leading end portion 32 provided at a leading end of the tooth main body portion 31. As illustrated in FIG. 2, the coil 13 is wound around the tooth main body portion 31. When the magnetic core 1 is incorporated in the brushless motor 100, the tooth leading end portion 32 faces the hard magnetic body 24 of the rotor 20 with an air gap interposed therebetween. In the present embodiment, a position in the second direction DIR2 of an end of the rotor member 22 in the second direction DIR2 is the same as a position in the second direction DIR2 of an end of the tooth leading end portion 32 in the second direction DIR2. In addition, a position in the fourth direction DIR4 of an end of the rotor member 22 in the fourth direction DIR4 is the same as a position in the fourth direction DIR4 of an end of the tooth leading end portion 32 in the fourth direction DIR4. The position in the second direction DIR2 of the end of the rotor member 22 in the second direction DIR2 does not have to be the same as the position in the second direction DIR2 of the end of the tooth leading end portion 32 in the second direction DIR2. In addition, the position in the fourth direction DIR4 of the end of the rotor member 22 in the fourth direction DIR4 does not have to be the same as the position in the fourth direction DIR4 of the end of the tooth leading end portion 32 in the fourth direction DIR4.

As illustrated in FIG. 3, the tooth leading end portion 32 includes the front surface IS32 facing in the first direction DIR1, a back surface OS32 facing in the direction opposite to the first direction DIR1, two side surfaces connecting the front surface IS32 and the back surface OS32 and arranged in the third direction DIR3, and two end surfaces connecting the front surface IS32 and the back surface OS32 and arranged in the second direction DIR2. In the present embodiment, each of the back surface OS32, the two side surfaces arranged in the third direction DIR3, and the two end surfaces arranged in the second direction DIR2 is a flat surface. The front surface IS32 is a curved surface curved in a depressed shape in the direction opposite to the first direction DIR1. The front surface IS32 extends along the outer peripheral surface of the rotor 20. Each of the back surface OS32, the two side surfaces arranged in the third direction DIR3, and the two end surfaces arranged in the second direction DIR2 may include a curved surface. In addition, the front surface IS32 may include a flat surface.

In the present embodiment, the tooth main body portion 31 has a quadrangular prism shape that extends in the first direction DIR1 and of which each corner is chamfered. More specifically, as illustrated in FIG. 4, the tooth main body portion 31 includes the first end surface ES1 facing in the second direction DIR2, a second end surface ES2 facing in the fourth direction DIR4, a first side surface SS1 facing in the third direction DIR3, a second side surface SS2 facing in a direction opposite to the third direction DIR3, and the four inclined surfaces SL connecting the first end surface ES1 or the second end surface ES2 and the first side surface SS1 or the second side surface SS2. In the present embodiment, each of the first end surface ES1 and the second end surface ES2 includes the first flat surface FS1 parallel to the first direction DIR1. Each of the first side surface SS1 and the second side surface SS2 includes a second flat surface FS2 parallel to the first direction DIR1. Each of the first end surface ES1 and the second end surface ES2 does not have to include the first flat surface FS1 parallel to the first direction DIR1. In addition, each of the first side surface SS1 and the second side surface SS2 does not have to include the second flat surface FS2 parallel to the first direction DIR1. In addition, the first end surface ES1 or the second end surface ES2 corresponds to an “end surface” in the present disclosure. The first side surface SS1 or the second side surface SS2 corresponds to a “side surface” in the present disclosure.

When the magnetic core 1 is viewed in the first direction DIR1, an outer edge of the tooth main body portion 31 is surrounded by an outer edge of the core back portion 2. In addition, when the magnetic core 1 is viewed in the first direction DIR1, the outer edge of the tooth main body portion 31 is surrounded by an outer edge of the tooth leading end portion 32. The tooth main body portion 31 does not have to have a quadrangular prism shape that extends in the first direction DIR1 and of which each corner is chamfered.

In the present embodiment, as illustrated in FIGS. 3 and 4, four first curved surface forming portions R1 are formed in the tooth main body portion 31. The four first curved surface forming portions R1 are parts of the tooth main body portion 31. One of the four first curved surface forming portions R1 is formed in the end portion of the tooth main body portion 31 in the first direction DIR1 and in the end portion of the tooth main body portion 31 in the second direction DIR2. One of the four first curved surface forming portions R1 is formed in the end portion of the tooth main body portion 31 in the direction opposite to the first direction DIR1 and in the end portion of the tooth main body portion 31 in the second direction DIR2. One of the four first curved surface forming portions R1 is formed in the end portion of the tooth main body portion 31 in the first direction DIR1 and in the end portion of the tooth main body portion 31 in the fourth direction DIR4. One of the four first curved surface forming portions R1 is formed in the end portion of the tooth main body portion 31 in the direction opposite to the first direction DIR1 and in the end portion of the tooth main body portion 31 in the fourth direction DIR4. In the present embodiment, the four first curved surface forming portions R1 have structures symmetric to each other. For this reason, description of the two first curved surface forming portions R1 formed in the end portions of the tooth main body portion 31 in the fourth direction DIR4 will be omitted. The number of first curved surface forming portions R1 does not have to be four. In addition, the first curved surface forming portions R1 do not have to have structures symmetric to each other.

First, the first curved surface forming portion R1 formed in the end portion of the tooth main body portion 31 in the first direction DIR1 and in the end portion of the tooth main body portion 31 in the second direction DIR2 will be described. Hereinafter, this first curved surface forming portion R1 will be referred to as the first curved surface forming portion R11.

The first curved surface forming portion R11 projects from the first flat surface FS1 of the first end surface ES1 in the second direction DIR2. In addition, the first curved surface forming portion R11 is located only on the second direction DIR2 side from the first flat surface FS1 of the first end surface ES1. More specifically, the first curved surface forming portion R11 has a first curved surface CS1. The first curved surface CS1 of the first curved surface forming portion R11 is curved in a depressed shape. In the present embodiment, the first curved surface CS1 of the first curved surface forming portion R11 is curved in an arc shape in a cross section orthogonal to the third direction DIR3. In addition, the first curved surface CS1 of the first curved surface forming portion R11 has one radius of curvature CR1. The first curved surface CS1 of the first curved surface forming portion R11 does not have to be curved in an arc shape in a cross section orthogonal to the third direction DIR3. In addition, the first curved surface CS1 of the first curved surface forming portion R11 may have a plurality of radii of curvature CR1.

The first curved surface CS1 of the first curved surface forming portion R11 is a part of the first end surface ES1. The first curved surface CS1 of the first curved surface forming portion R11 is smoothly connected to the back surface OS32 of the tooth leading end portion 32. This means that the tooth main body portion 31 is smoothly connected to the back surface OS32 of the tooth leading end portion 32 with the first curved surface CS1 of the first curved surface forming portion R11 interposed therebetween. In the present embodiment, as illustrated in FIG. 3, an edge E is formed at each of an end of the first curved surface CS1 of the first curved surface forming portion R11 in the third direction DIR3 and an end of the first curved surface CS1 of the first curved surface forming portion R11 in the direction opposite to the third direction DIR3.

Next, the first curved surface forming portion R1 formed in the end portion of the tooth main body portion 31 in the direction opposite to the first direction DIR1 and in the end portion of the tooth main body portion 31 in the second direction DIR2 will be described. Hereinafter, this first curved surface forming portion R1 will be referred to as a first curved surface forming portion R12.

As illustrated in FIG. 4, in the second direction DIR2, the first curved surface forming portion R12 projects from the first flat surface FS1 of the first end surface ES1 in the second direction DIR2. In addition, the first curved surface forming portion R12 is located only on the second direction DIR2 side from the first flat surface FS1 of the first end surface ES1. More specifically, the first curved surface forming portion R12 has a first curved surface CS1. The first curved surface CS1 of the first curved surface forming portion R12 is curved in a depressed shape. In the present embodiment, the first curved surface CS1 of the first curved surface forming portion R12 is curved in an arc shape in a cross section orthogonal to the third direction DIR3. In addition, the first curved surface CS1 of the first curved surface forming portion R12 has one radius of curvature CR1. The first curved surface CS1 of the first curved surface forming portion R12 does not have to be curved in an arc shape in a cross section orthogonal to the third direction DIR3. In addition, the first curved surface CS1 of the first curved surface forming portion R12 may have a plurality of radii of curvature CR1.

The first curved surface CS1 of the first curved surface forming portion R12 is a part of the first end surface ES1. The first curved surface CS1 of the first curved surface forming portion R12 is smoothly connected to the front surface IS2 of the core back portion 2. This means that the tooth main body portion 31 is smoothly connected to the front surface IS2 of the core back portion 2 with the first curved surface CS1 of the first curved surface forming portion R12 interposed therebetween. In the present embodiment, an edge E is formed at each of an end of the first curved surface CS1 of the first curved surface forming portion R12 in the third direction DIR3 and an end of the first curved surface CS1 of the first curved surface forming portion R12 in the direction opposite to the third direction DIR3.

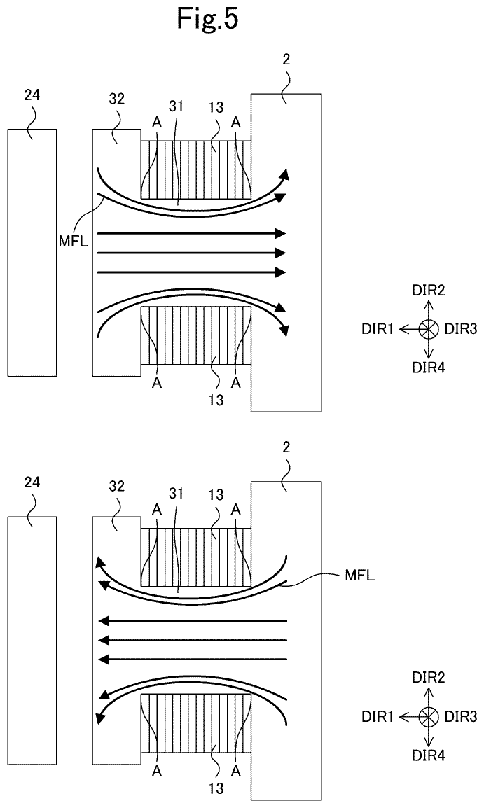

In the magnetic core 1, the occurrence of magnetic saturation can be reduced. As a comparative example, a magnetic core 50 in which the first curved surface forming portion R1 is not formed in the tooth main body portion 31 will be described with reference to the drawings. FIG. 5 is a sectional view illustrating a magnetic flux flowing in the magnetic core 50 according to the comparative example in a motor including the magnetic core 50 according to the comparative example. In FIG. 5, among a plurality of magnetic force lines MFL, only the representative magnetic force line MFL is denoted by the reference numeral. In addition, in FIG. 5, for description, a boundary between the tooth main body portion 31 and the core back portion 2 and a boundary between the tooth main body portion 31 and the tooth leading end portion 32 are omitted.

In the brushless motor 100, energization of the coil 13 wound around the tooth main body portion 31 generates a magnetic flux in the tooth main body portion 31. The magnetic flux flows from the tooth main body portion 31 toward the front surface IS2 of the core back portion 2 or the back surface OS32 of the tooth leading end portion 32. A flow direction of the magnetic flux can be changed by changing a flow direction of a current in the coil 13. At this time, the magnetic flux tends to flow in a shortest route inside the magnetic core 50 according to the comparative example. In the magnetic core 50 according to the comparative example, a corner A is formed in each of portions where the first end surface ES1 of the tooth main body portion 31 is connected to the front surface IS2 of the core back portion 2 and the back surface OS32 of the tooth leading end portion 32.

In the magnetic core 50 according to the comparative example, the flow of the magnetic flux is disturbed by each corner A, and the magnetic flux has to take a detour in a portion near the corner A and does not easily flow. In the portion near the corner A, a residual stress is generated, and magnetic resistance in a magnetic circuit increases, as a result of which magnetic saturation locally occurs in the portion of the corner A. Therefore, when the magnetic core 50 according to the comparative example is used in a motor, output torque of the motor cannot be improved.

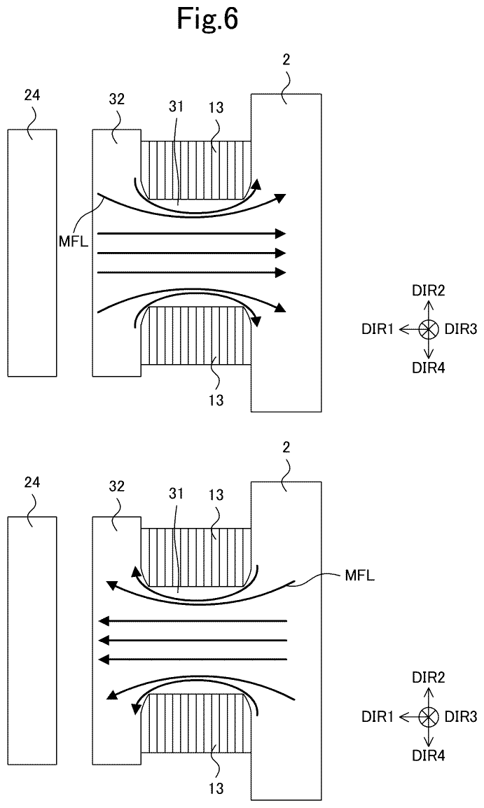

Next, the magnetic core 1 will be described with reference to the drawings. FIG. 6 is a sectional view illustrating a magnetic flux flowing in the magnetic core 1 in the brushless motor 100. In FIG. 6, for description, the boundary between the tooth main body portion 31 and the core back portion 2 and the boundary between the tooth main body portion 31 and the tooth leading end portion 32 are omitted. In addition, in FIG. 6, among the plurality of magnetic force lines MFL, only the representative magnetic force line MFL is denoted by the reference numeral.

In the magnetic core 1, the first curved surface forming portion R11 having the first curved surface CS1 curved in a depressed shape is formed in the tooth main body portion 31. The first curved surface CS1 of the first curved surface forming portion R11 is smoothly connected to the back surface OS32 of the tooth leading end portion 32. As illustrated in FIG. 6, since the first curved surface forming portion R11 is formed in the tooth main body portion 31, in a portion near the first curved surface forming portion R11, the magnetic flux can flow in the shortest route without taking a detour. This means that in the magnetic core 1, compared to the magnetic core 50 according to the comparative example, the magnetic flux easily flows in the portion near the first curved surface forming portion R11. As a result, in the portion near the first curved surface forming portion R11, the occurrence of magnetic saturation can be reduced.

In addition, since the first curved surface forming portion R11 is formed in the tooth main body portion 31, the magnetic core 1 can further receive a magnetic flux generated by the hard magnetic body 24 and including a component in the second direction DIR2 or the fourth direction DIR4. This effect is more remarkable when the end of the rotor member 22 in the second direction DIR2 is located further in the second direction DIR2 than is the end of the tooth main body portion 31 in the second direction DIR2 and there is a longer distance in the second direction DIR2 between the end of the rotor member 22 in the second direction DIR2 and the end of the tooth main body portion 31 in the second direction DIR2, or when the end of the rotor member 22 in the fourth direction DIR4 is located further in the fourth direction DIR4 than is the end of the tooth main body portion 31 in the fourth direction DIR4 and there is a longer distance in the fourth direction DIR4 between the end of the rotor member 22 in the fourth direction DIR4 and the end of the tooth main body portion 31 in the fourth direction DIR4.

Since the first curved surface CS1 of the first curved surface forming portion R11 is curved in a depressed shape, compared to a case where the first curved surface CS1 of the first curved surface forming portion R11 is curved in a projecting shape, the number of turns in the coil 13 around the tooth main body portion 31 can be increased. As a result, the slot fill factor of the coil 13 can be increased, and the output torque of the brushless motor 100 can be improved.

In addition, in the magnetic core 1, in the second direction DIR2, the first curved surface forming portion R11 projects from the first flat surface FS1 of the first end surface ES1 in the second direction DIR2 and is located only on the second direction DIR2 side from the first flat surface FS1 of the first end surface ES1. In other words, in the second direction DIR2, the first curved surface forming portion R11 is formed without reducing a cross-sectional area of the tooth main body portion 31. Therefore, the formation of the first curved surface forming portion R11 does not lower a saturated magnetic flux density of the magnetic flux flowing inside the tooth main body portion 31. As a result, a reduction in output torque of the brushless motor 100 can be suppressed.

In the magnetic core 1, the first curved surface forming portion R12 having the first curved surface CS1 curved in a depressed shape is formed in the tooth main body portion 31. The first curved surface CS1 of the first curved surface forming portion R12 is smoothly connected to the front surface IS2 of the core back portion 2. Since the first curved surface forming portion R12 is formed in the tooth main body portion 31, in a portion near the first curved surface forming portion R12, the magnetic flux can flow in the shortest route without taking a detour. This means that in the magnetic core 1, compared to the magnetic core 50 according to the comparative example, the magnetic flux easily flows in the portion near the first curved surface forming portion R12. As a result, in the portion near the first curved surface forming portion R12, the occurrence of magnetic saturation can be reduced.

Since the first curved surface CS1 of the first curved surface forming portion R12 is curved in a depressed shape, compared to a case where the first curved surface CS1 of the first curved surface forming portion R12 is curved in a projecting shape, the number of turns in the coil 13 around the tooth main body portion 31 can be increased. As a result, the slot fill factor of the coil 13 can be increased, and the output torque of the brushless motor 100 can be improved.

Since the first curved surface forming portion R12 is formed in the tooth main body portion 31, in the core back portion 2, in a direction orthogonal to the first direction DIR1, a region in which the magnetic flux flows can be increased. More specifically, when the magnetic core 1 is incorporated in the brushless motor 100, the adjacent magnetic cores 1 are connected to each other by the core back portions 2 thereof. Hereinafter, one of the adjacent magnetic cores 1 will be referred to as a magnetic core 11, and the other one will be referred to as a magnetic core 12.

When a magnetic flux generated in the tooth main body portion 31 of the magnetic core 11 by energization of the coil 13 wound around the tooth main body portion 31 of the magnetic core 11 flows from the tooth main body portion 31 of the magnetic core 11 toward the front surface IS2 of the core back portion 2 of the magnetic core 11, a magnetic flux is formed in a direction from the core back portion 2 of the magnetic core 11 toward the core back portion 2 of the magnetic core 12 (the third direction DIR3).

While the magnetic flux tends to flow in the shortest route, a repulsive force is generated between a plurality of magnetic fluxes, and the plurality of magnetic fluxes has a property of spreading in a direction orthogonal to the first direction DIR1 and the third direction DIR3 (the second direction DIR2 and the fourth direction DIR4). In the magnetic core 50 according to the comparative example, since the first curved surface forming portion R1 is not formed on the core back portion 2 side of the tooth main body portion 31, the corner A is formed in the portion where the first end surface ES1 of the tooth main body portion 31 is connected to the front surface IS2 of the core back portion 2. Due to the corner A, the flow of each magnetic flux that tends to spread in the second direction DIR2 and the fourth direction DIR4 is disturbed. Therefore, in the core back portion 2, in the second direction DIR2 and the fourth direction DIR4, the region in which the magnetic flux flows cannot be increased, and the core back portion 2 cannot be effectively utilized as a magnetic circuit. If the region in which the magnetic flux flows cannot be increased, an increase in magnetic resistance in the magnetic circuit occurs, and in a case where the magnetic core 50 according to the comparative example is used in a motor, a reduction in output efficiency of the motor occurs.

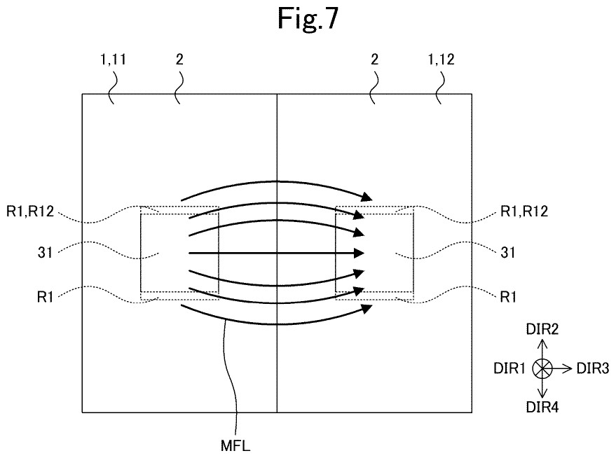

Next, the magnetic core 1 will be described with reference to the drawings. FIG. 7 is a sectional view illustrating a magnetic flux flowing in two magnetic cores 1 adjacent to each other in the brushless motor 100. In FIG. 7, among the plurality of magnetic force lines MFL, only the representative magnetic force line MFL is denoted by the reference numeral.

In the magnetic core 11, since the first curved surface forming portion R12 is formed in the tooth main body portion 31, in the portion near the first curved surface forming portion R12, the flow of the magnetic flux is not disturbed by a corner, and the magnetic flux easily spreads in the second direction DIR2. In addition, in the magnetic core 12, since the first curved surface forming portion R12 is formed in the tooth main body portion 31, in the portion near the first curved surface forming portion R12, the flow of the magnetic flux is not disturbed by a corner, and the magnetic flux easily spreads in the second direction DIR2. In other words, in the magnetic core 11, the magnetic flux easily flows out toward the magnetic core 12, and in the magnetic core 12, the magnetic flux easily flows in from the magnetic core 11. Therefore, an increase in magnetic resistance in the magnetic circuit can be suppressed. As a result, a reduction in output efficiency of the brushless motor 100 can be suppressed.

In addition, in the magnetic core 1, in the second direction DIR2, the first curved surface forming portion R12 projects from the first flat surface FS1 of the first end surface ES1 in the second direction DIR2 and is located only on the second direction DIR2 side from the first flat surface FS1 of the first end surface ES1. In other words, in the second direction DIR2, the first curved surface forming portion R12 is formed without reducing the cross-sectional area of the tooth main body portion 31. Therefore, the formation of the first curved surface forming portion R12 does not lower the saturated magnetic flux density of the magnetic flux flowing inside the tooth main body portion 31. As a result, a reduction in output torque of the brushless motor 100 can be suppressed.

### Method for Manufacturing Magnetic Core 1

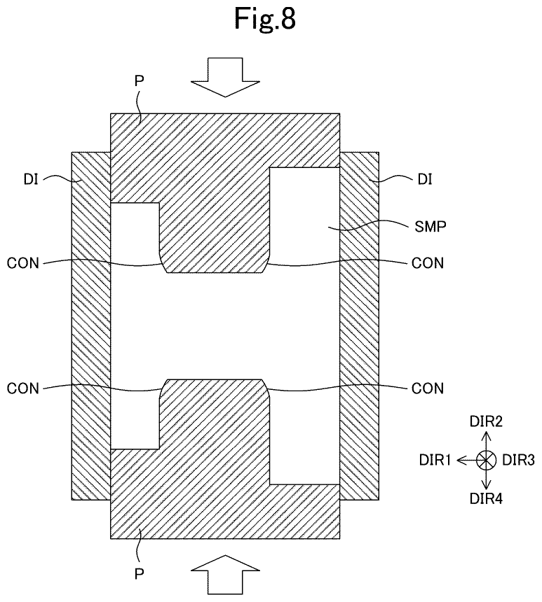

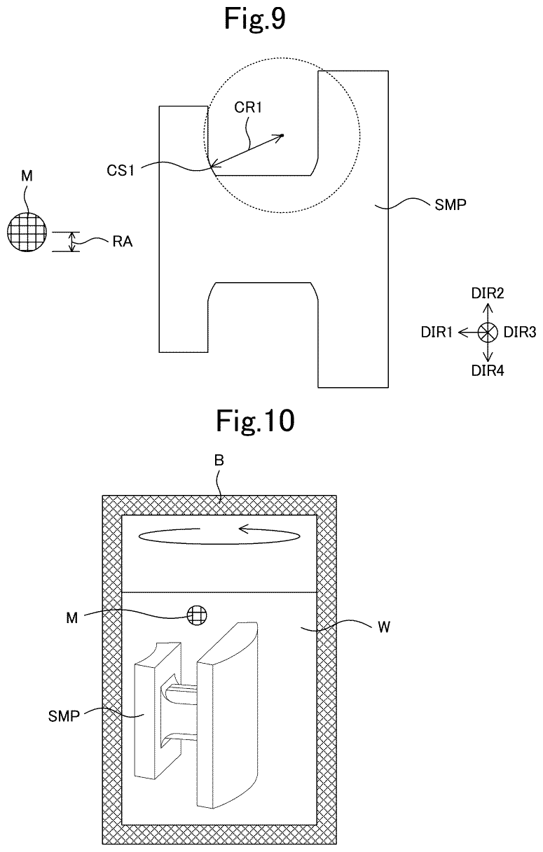

Hereinafter, a method for manufacturing the magnetic core 1 according to the first embodiment of the present disclosure will be described with reference to the drawings. FIG. 8 is a sectional view illustrating an example of a process of manufacturing the magnetic core 1. FIG. 9 illustrates a relationship between the radius of curvature CR1 of the first curved surface CS1 and a radius RA of a medium M. In FIG. 9, among the four first curved surfaces CS1, only the representative first curved surface CS1 is denoted by the reference numeral. FIG. 10 is a sectional view illustrating an inside of a barrel B in a finishing step.

As illustrated in FIG. 8, first, a die DI is filled with a soft magnetic powder SMP that is a mixture of an iron powder and an epoxy resin powder. Next, the soft magnetic powder SMP in the die DI is pressurized by a punch P so that compaction molding is performed on the soft magnetic powder SMP. The punch P includes a projecting surface CON curved in a projecting shape. In the present embodiment, the number of projecting surfaces CON is four. Therefore, when compaction molding is performed on the soft magnetic powder SMP, the four first curved surface forming portions R1 are formed in the tooth main body portion 31. At this point, due to a small gap between the die DI and the punch P, a rough surface of the punch P, or the like, burrs are formed on a surface of the soft magnetic powder compact SMP. As illustrated in FIG. 9, the radius of curvature CR1 of the first curved surface CS1 of the soft magnetic powder compact SMP is larger than the radius RA of the medium M. When the first curved surface CS1 of the soft magnetic powder compact SMP has a plurality of radii of curvature CR1, it is sufficient that a minimum value of the plurality of radii of curvature CR1 be larger than the radius RA of the medium M.

In the present manufacturing method, after the compaction molding is performed on the soft magnetic powder SMP, the finishing step in which the magnetic core 1 is finished through polishing is performed. As illustrated in FIG. 10, in the finishing step, first, the soft magnetic powder compact SMP, the medium M, a polishing aid (not illustrated), and water W are put into the barrel B that is hollow inside. The medium M has a spherical shape with the radius RA. In the present embodiment, the number of soft magnetic powder compacts SMP and the number of media M are both one, but the number of soft magnetic powder compacts SMP and the number of media M may be two or more. When the number of media M is two or more, the magnetic core 1 can be efficiently finished. When the number of soft magnetic powder compacts SMP is two or more, a plurality of magnetic cores 1 can be simultaneously finished.

In the finishing step, while the barrel B is rotated, the medium M collides with the soft magnetic powder compact SMP to polish the soft magnetic powder compact SMP. In the finishing step, while the medium M polishes the soft magnetic powder compact SMP, burrs formed on the surface of the soft magnetic powder compact SMP before the finishing step are removed, and the magnetic core 1 is finished. In the finishing step, a method for polishing the soft magnetic powder compact SMP using the medium M need not be implemented through rotating of the barrel B, and may be implemented through vibrating of the barrel B. In addition, in the finishing step, the barrel B is not necessary, and it is sufficient that the soft magnetic powder compact SMP be polished by the medium M. Similarly, in the finishing step, the polishing aid and the water W are not necessary.

The magnetic core 1 is a molded body formed from a soft magnetic powder. Therefore, compared to a case where a magnetic core is formed of stacked electromagnetic steel sheets, as described in the above-described method for manufacturing the magnetic core 1, each first curved surface forming portion R1 can be easily formed. As a result, the magnetic core 1 can be easily manufactured.

In the method for manufacturing the magnetic core 1, burrs formed on the first curved surface CS1 before the finishing step can be removed in the finishing step. More specifically, the radius of curvature CR1 of the first curved surface CS1 of the soft magnetic powder compact SMP is larger than the radius RA of the medium M. Therefore, in the finishing step, the medium M can come into contact with the entire first curved surface CS1, and the burrs formed on the first curved surface CS1 before the finishing step can be removed in the finishing step. As a result, when the coil 13 is wound around the tooth main body portion 31 after the magnetic core 1 is completed, damage to the coil 13 can be suppressed.

In addition, as illustrated in the above-described magnetic core 1, after the finishing step, when an insulating film is applied to a surface of the magnetic core 1, the insulating film can be made thinner since there are no burrs. As a result, the slot fill factor of the coil 13 can be increased, and the output efficiency of the brushless motor 100 can be improved.

### First Modification

### Configuration of Magnetic Core 1a

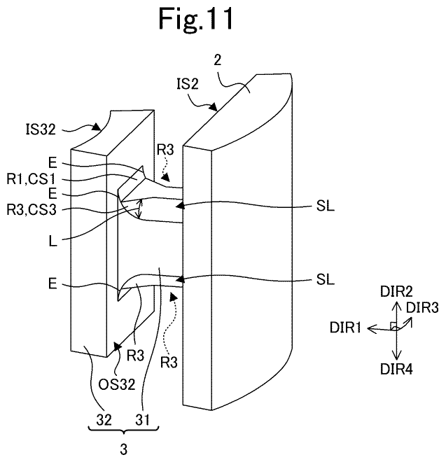

Hereinafter, a configuration of a magnetic core 1a according to a first modification of the present disclosure will be described with reference to the drawings. FIG. 11 is a perspective view of the magnetic core 1a. In FIG. 11, among the four first curved surface forming portions R1 and the four first curved surfaces CS1, only the representative first curved surface forming portion R1 and the representative first curved surface CS1 are denoted by the reference numerals. In addition, only portions of the magnetic core 1a according to the first modification different from those of the magnetic core 1 according to the first embodiment will be described, and description of the other portions will be omitted.

As illustrated in FIG. 11, the magnetic core 1a is different from the magnetic core 1 in that four third curved surface forming portions R3 are formed in the tooth main body portion 31.

The four third curved surface forming portions R3 are parts of the tooth main body portion 31. One of the four third curved surface forming portions R3 is formed in the end portion of the tooth main body portion 31 in the direction opposite to the third direction DIR3 and in the end portion of the tooth main body portion 31 in the second direction DIR2. One of the four third curved surface forming portions R3 is formed in the end portion of the tooth main body portion 31 in the direction opposite to the third direction DIR3 and in the end portion of the tooth main body portion 31 in the fourth direction DIR4. One of the four third curved surface forming portions R3 is formed in the end portion of the tooth main body portion 31 in the third direction DIR3 and in the end portion of the tooth main body portion 31 in the second direction DIR2. One of the four third curved surface forming portions R3 is formed in the end portion of the tooth main body portion 31 in the third direction DIR3 and in the end portion of the tooth main body portion 31 in the fourth direction DIR4. In the present modification, the four third curved surface forming portions R3 have structures symmetric to each other. The number of third curved surface forming portions R3 does not have to be four. In addition, the third curved surface forming portions R3 do not have to have structures symmetric to each other.

Each of the four third curved surface forming portions R3 has a third curved surface CS3. The third curved surface CS3 of each of the four third curved surface forming portions R3 is a part of the corresponding one of the four inclined surfaces SL. The third curved surface CS3 of each of the four third curved surface forming portions R3 is tapered. More specifically, the third curved surface CS3 of each of the four third curved surface forming portions R3 on the core back portion 2 side of the tooth main body portion 31 is tapered toward the core back portion 2. In addition, the third curved surface CS3 of each of the four third curved surface forming portions R3 on the tooth leading end portion 32 side of the tooth main body portion 31 is tapered toward the tooth leading end portion 32. The third curved surface CS3 is smoothly connected to the edge E of the first curved surface CS1 in the third direction DIR3.

The above-described magnetic core 1a also provides the same effects as the magnetic core 1. In addition, in the magnetic core 1a, since the third curved surface forming portions R3 are formed in the tooth main body portion 31, on the core back portion 2 side or the tooth leading end portion 32 side of the tooth main body portion 31, the flow of the magnetic flux is not disturbed by a corner and easily flows in a portion where the first end surface ES1 or the second end surface ES2 of the tooth main body portion 31 and the first side surface SS1 or the second side surface SS2 are connected to each other. As a result, the occurrence of local magnetic saturation can be further reduced.

### Second Modification

### Configuration of Magnetic Core 1b

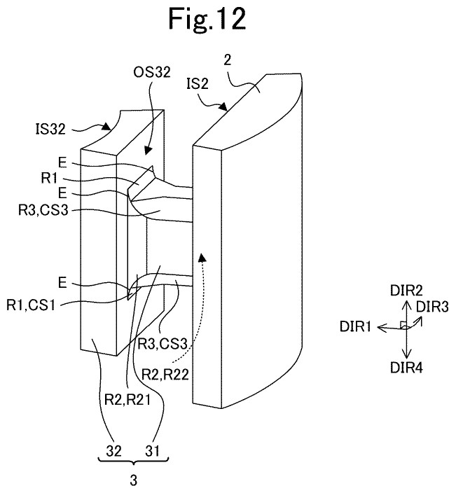

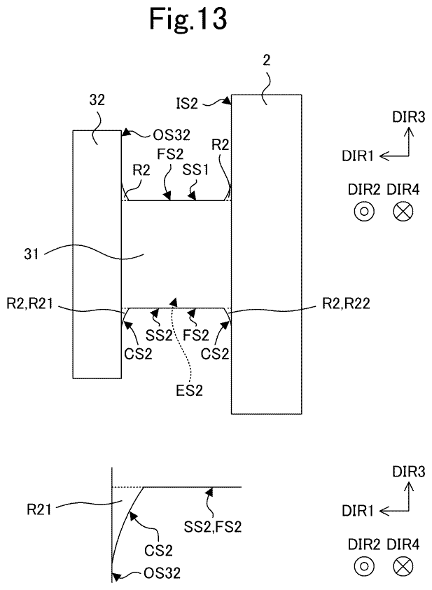

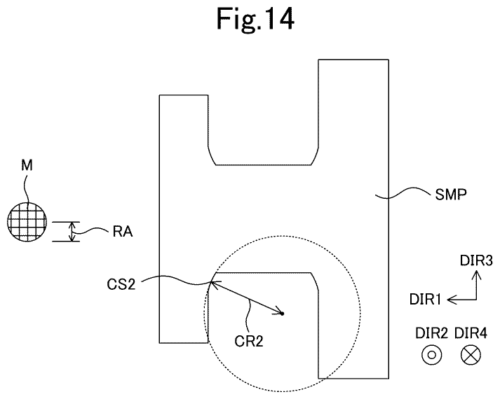

Hereinafter, a configuration of a magnetic core 1b according to a second modification of the present disclosure will be described with reference to the drawings. FIG. 12 is a perspective view of the magnetic core 1b. FIG. 13 includes a sectional view of the magnetic core 1b and an enlarged sectional view of a portion near a second curved surface forming portion R21. A cross section of the magnetic core 1b in FIG. 13 is taken in a plane passing through the second flat surface FS2 of the second side surface SS2 of the tooth main body portion 31 and orthogonal to the second flat surface FS2 of the second side surface SS2 of the tooth main body portion 31. FIG. 14 illustrates a relationship between a radius of curvature CR2 of a second curved surface CS2 and the radius RA of the medium M. In FIG. 14, among the four second curved surfaces CS2, only the representative second curved surface CS2 is denoted by the reference numeral. In addition, only portions of the magnetic core 1b according to the second modification different from those of the magnetic core 1a according to the first modification will be described, and description of the other portions will be omitted.

As illustrated in FIGS. 12 and 13, the magnetic core 1b is different from the magnetic core 1a in that four second curved surface forming portions R2 are formed in the tooth main body portion 31.

The four second curved surface forming portions R2 are parts of the tooth main body portion 31. One of the four second curved surface forming portions R2 is formed in the end portion of the tooth main body portion 31 in the first direction DIR1 and in the end portion of the tooth main body portion 31 in the direction opposite to the third direction DIR3. One of the four second curved surface forming portions R2 is formed in the end portion of the tooth main body portion 31 in the direction opposite to the first direction DIR1 and in the end portion of the tooth main body portion 31 in the direction opposite to the third direction DIR3. One of the four second curved surface forming portions R2 is formed in the end portion of the tooth main body portion 31 in the first direction DIR1 and in the end portion of the tooth main body portion 31 in the third direction DIR3. One of the four second curved surface forming portions R2 is formed in the end portion of the tooth main body portion 31 in the direction opposite to the first direction DIR1 and in the end portion of the tooth main body portion 31 in the third direction DIR3. In the present modification, the four second curved surface forming portions R2 have structures symmetric to each other. For this reason, description of the two second curved surface forming portions R2 formed in the end portions of the tooth main body portion 31 in the third direction DIR3 will be omitted. The number of second curved surface forming portions R2 does not have to be four. In addition, the second curved surface forming portions R2 do not have to have structures symmetric to each other.

First, the second curved surface forming portion R2 formed in the end portion of the tooth main body portion 31 in the first direction DIR1 and in the end portion of the tooth main body portion 31 in the direction opposite to the third direction DIR3 will be described. Hereinafter, this second curved surface forming portion R2 will be referred to as the second curved surface forming portion R21.

In the direction opposite to the third direction DIR3, the second curved surface forming portion R21 projects from the second flat surface FS2 of the second side surface SS2 in the direction opposite to the third direction DIR3. In addition, the second curved surface forming portion R21 is located only on a side opposite to the third direction DIR3 side from the second flat surface FS2 of the second side surface SS2. More specifically, the second curved surface forming portion R21 has the second curved surface CS2. The second curved surface CS2 of the second curved surface forming portion R21 is curved in a depressed shape. In the present modification, the second curved surface CS2 of the second curved surface forming portion R21 is curved in an arc shape in a cross section orthogonal to the second direction DIR2. In addition, the second curved surface CS2 of the second curved surface forming portion R21 has one radius of curvature CR2. The second curved surface CS2 of the second curved surface forming portion R21 does not have to be curved in an arc shape in a cross section orthogonal to the second direction DIR2. In addition, the second curved surface CS2 of the second curved surface forming portion R21 may have a plurality of radii of curvature CR2.

The second curved surface CS2 of the second curved surface forming portion R21 is a part of the second side surface SS2. The second curved surface CS2 of the second curved surface forming portion R21 is smoothly connected to the back surface OS32 of the tooth leading end portion 32. This means that the tooth main body portion 31 is smoothly connected to the back surface OS32 of the tooth leading end portion 32 with the second curved surface CS2 of the second curved surface forming portion R21 interposed therebetween.

Next, the second curved surface forming portion R2 formed in the end portion of the tooth main body portion 31 in the direction opposite to the first direction DIR1 and in the end portion of the tooth main body portion 31 in the direction opposite to the third direction DIR3 will be described. Hereinafter, this second curved surface forming portion R2 will be referred to as a second curved surface forming portion R22.

In the direction opposite to the third direction DIR3, the second curved surface forming portion R22 projects from the second flat surface FS2 of the second side surface SS2 in the direction opposite to the third direction DIR3. In addition, the second curved surface forming portion R22 is located only on the side opposite to the third direction DIR3 side from the second flat surface FS2 of the second side surface SS2. More specifically, the second curved surface forming portion R22 has the second curved surface CS2. The second curved surface CS2 of the second curved surface forming portion R22 is curved in a depressed shape. In the present modification, the second curved surface CS2 of the second curved surface forming portion R22 is curved in an arc shape in a cross section orthogonal to the second direction DIR2. In addition, the second curved surface CS2 of the second curved surface forming portion R22 has one radius of curvature CR2. The second curved surface CS2 of the second curved surface forming portion R22 does not have to be curved in an arc shape in a cross section orthogonal to the second direction DIR2. In addition, the second curved surface CS2 of the second curved surface forming portion R22 may have a plurality of radii of curvature CR2.

The second curved surface CS2 of the second curved surface forming portion R22 is a part of the second side surface SS2. The second curved surface CS2 of the second curved surface forming portion R22 is smoothly connected to the front surface IS2 of the core back portion 2. This means that the tooth main body portion 31 is smoothly connected to the front surface IS2 of the core back portion 2 with the second curved surface CS2 of the second curved surface forming portion R22 interposed therebetween.

A method for manufacturing the magnetic core 1b according to the present modification is the same as the method for manufacturing the magnetic core 1 according to the first embodiment. However, as illustrated in FIG. 14, the radius of curvature CR2 of the second curved surface CS2 of the soft magnetic powder compact SMP is larger than the radius RA of the medium M. When the second curved surface CS2 of the soft magnetic powder compact SMP has a plurality of radii of curvature CR2, it is sufficient that a minimum value of the plurality of radii of curvature CR2 be larger than the radius RA of the medium M.

The above-described magnetic core 1b also provides the same effects the magnetic core 1a. In addition, in the magnetic core 1b, the second curved surface forming portion R21 having the second curved surface CS2 curved in a depressed shape is formed in the tooth main body portion 31. The second curved surface CS2 of the second curved surface forming portion R21 is smoothly connected to the back surface OS32 of the tooth leading end portion 32. Since the second curved surface forming portion R21 is formed in the tooth main body portion 31, in a portion near the second curved surface forming portion R21, the magnetic flux can flow in the shortest route without taking a detour. This means that in the magnetic core 1b, compared to the magnetic core 50 according to the comparative example, the magnetic flux easily flows in the portion near the second curved surface forming portion R21. As a result, in the portion near the second curved surface forming portion R21, the occurrence of magnetic saturation can be reduced.

Since the second curved surface CS2 of the second curved surface forming portion R21 is curved in a depressed shape, compared to a case where the second curved surface CS2 of the second curved surface forming portion R21 is curved in a projecting shape, the number of turns in the coil 13 around the tooth main body portion 31 can be increased. As a result, the slot fill factor of the coil 13 can be increased, and the output torque of the brushless motor 100 can be improved.

In addition, in the magnetic core 1b, in the direction opposite to the third direction DIR3, the second curved surface forming portion R21 projects from the second flat surface FS2 of the second side surface SS2 and is located only on the side opposite to the third direction DIR3 side from the second flat surface FS2 of the second side surface SS2. In other words, in the direction opposite to the third direction DIR3, the second curved surface forming portion R21 is formed without reducing the cross-sectional area of the tooth main body portion 31. Therefore, the formation of the second curved surface forming portion R21 does not lower the saturated magnetic flux density of the magnetic flux flowing inside the tooth main body portion 31. As a result, a reduction in output torque of the brushless motor 100 can be suppressed.

In the magnetic core 1b, the second curved surface forming portion R22 having the second curved surface CS2 curved in a depressed shape is formed in the tooth main body portion 31. The second curved surface CS2 of the second curved surface forming portion R22 is smoothly connected to the front surface IS2 of the core back portion 2. Since the second curved surface forming portion R22 is formed in the tooth main body portion 31, in a portion near the second curved surface forming portion R22, the magnetic flux can flow in the shortest route without taking a detour. This means that in the magnetic core 1b, compared to the magnetic core 50 according to the comparative example, the magnetic flux easily flows in the portion near the second curved surface forming portion R22. As a result, in the portion near the second curved surface forming portion R22, the occurrence of magnetic saturation can be reduced.

Since the second curved surface CS2 of the second curved surface forming portion R22 is curved in a depressed shape, compared to a case where the second curved surface CS2 of the second curved surface forming portion R22 is curved in a projecting shape, the number of turns in the coil 13 around the tooth main body portion 31 can be increased. As a result, the slot fill factor of the coil 13 can be increased, and the output torque of the brushless motor 100 can be improved.

In the method for manufacturing the magnetic core 1b, burrs formed on the second curved surface CS2 before the finishing step can be removed in the finishing step. More specifically, the radius of curvature CR2 of the second curved surface CS2 of the soft magnetic powder compact SMP is larger than the radius RA of the medium M. Therefore, in the finishing step, the medium M can come into contact with the entire second curved surface CS2, and the burrs formed on the second curved surface CS2 before the finishing step can be removed in the finishing step. As a result, when the coil 13 is wound around the tooth main body portion 31 after the magnetic core 1b is completed, damage to the coil 13 can be suppressed.

### Other Embodiments

The magnetic core according to the present disclosure is not limited to the magnetic core 1, the magnetic core 1a, or the magnetic core 1b and can be modified within the spirit of the present disclosure. In addition, the structures of the magnetic core 1, the magnetic core 1a, or the magnetic core 1b may be combined in any manner.

The rotary electric machine need only include the magnetic core 1, the magnetic core 1a, or the magnetic core 1b and may include a brush.

The present disclosure has the following configurations.

(1) A magnetic core for use in a rotary electric machine, the magnetic core including: a core back portion including a front surface that faces in a first direction toward a rotation axis of the rotary electric machine when the magnetic core is incorporated in the rotary electric machine; a tooth portion, wherein the tooth portion includes: a tooth main body portion extending from the front surface in the first direction, and a tooth leading end portion at a leading end of the tooth main body portion, wherein the tooth leading end portion includes a back surface facing in a direction opposite to the first direction, the tooth main body portion includes an end surface that faces in a second direction along the rotation axis when the magnetic core is incorporated in the rotary electric machine; and a first curved surface forming portion that is a part of the end surface of the tooth main body portion, the first curved surface forming portion including a curved surface having a depressed shape and that is connected to the front surface of the core back portion or the back surface of the tooth leading end portion.

(2) The magnetic core according to (1), wherein the end surface includes a first flat surface parallel to the first direction, and the first curved surface forming portion projects from the first flat surface in the second direction and is located only on a second direction side relative to the first flat surface.

(3) The magnetic core according to (1) or (2), wherein the curved surface is a first curved surface, the tooth main body portion includes a side surface that faces in a circumferential direction with the rotation axis as a center when the magnetic core is incorporated in the rotary electric machine, and the magnetic core further includes a second curved surface forming portion that is a part of the side surface of the tooth main body portion, the second curved surface forming portion including a second curved surface having a depressed shape and that is connected to the front surface of the core back portion or the back surface of the tooth leading end portion.

(4) The magnetic core according to (3), wherein the side surface includes a second flat surface parallel to the first direction, and the second curved surface forming portion projects from the second flat surface in the circumferential direction and is located only on the circumferential direction side from the second flat surface.

(5) The magnetic core according to any one of (1) to (4), wherein the tooth main body portion includes a side surface facing in a third direction that is a circumferential direction with the rotation axis as a center when the magnetic core is incorporated in the rotary electric machine, and an inclined surface connecting the end surface and the side surface, and a third curved surface forming portion that is a part of the inclined surface of the tooth main body portion, the third curved surface forming portion including a tapered and curved surface that is connected to an edge of the curved surface of the end surface in the third direction.

(6) The magnetic core according to any one of (1) to (5), wherein the magnetic core is a molded body comprising a soft magnetic powder.

(7) A magnetic core with a coil, including: the magnetic core according to any one of (1) to (6); and a coil wound around the tooth main body portion.

(8) A rotary electric machine including: the magnetic core according to any one of (1) to (6).

(9) A method for manufacturing a magnetic core, including finishing the magnetic core according to any one of (1) to (6) through polishing using a spherical medium, wherein before the finishing of the magnetic core, the magnetic core is manufactured such that a radius of curvature of the curved surface of the end surface is larger than a radius of the medium used in the finishing of the magnetic core.

(10) A method for manufacturing a magnetic core, including finishing the magnetic core according to (3) or (4) through polishing using a spherical medium, wherein before the finishing of the magnetic core, the magnetic core is manufactured such that a radius of curvature of the curved surface of the side surface is larger than a radius of the medium used in the finishing of the magnetic core.

### REFERENCE SIGNS LIST

1, 11, 12, 1a, 1b magnetic core
2 core back portion
3 tooth portion
10 stator
13 coil
14 bearing
14a first bearing
14b second bearing
15 housing
15a first housing
15b second housing
20 rotor
21 shaft
22 rotor member
23 soft magnetic body
24 hard magnetic body
31 tooth main body portion
32 tooth leading end portion
100 brushless motor
A corner
B barrel
CON projecting surface
CR1, CR2 radius of curvature
CS1 first curved surface
CS2 second curved surface
CS3 third curved surface
DI die
DIR1 first direction
DIR2 second direction
DIR3 third direction
DIR4 fourth direction
ES1 first end surface
ES2 second end surface
FS1 first flat surface
FS2 second flat surface
IS2, IS32 front surface
M medium
MFL magnetic force line
OP opening
OS2, OS32 back surface
P punch
R1, R11, R12 first curved surface forming portion
R2, R21, R22 second curved surface forming portion
R3 third curved surface forming portion
RA radius
SMP soft magnetic powder
SS1 first side surface
SS2 second side surface
SL inclined surface
W water

1. A magnetic core for use in a rotary electric machine, the magnetic core comprising:
a core back portion including a front surface that faces in a first direction toward a rotation axis of the rotary electric machine when the magnetic core is incorporated in the rotary electric machine;
a tooth portion, wherein the tooth portion includes:
a tooth main body portion extending from the front surface in the first direction, and
a tooth leading end portion at a leading end of the tooth main body portion, wherein
the tooth leading end portion includes a back surface facing in a direction opposite to the first direction,
the tooth main body portion includes an end surface that faces in a second direction along the rotation axis when the magnetic core is incorporated in the rotary electric machine; and
a first curved surface forming portion that is a part of the end surface of the tooth main body portion, the first curved surface forming portion including a curved surface having a depressed shape and that is connected to the front surface of the core back portion or the back surface of the tooth leading end portion.

2. The magnetic core according to claim 1, wherein
the end surface of the tooth main body portion is a first end surface, the curved surface is a first curved surface, and the tooth main body portion includes a second end surface that faces in a fourth direction along the rotation axis when the magnetic core is incorporated in the rotary electric machine, the fourth direction being opposite the second direction, and
the magnetic core further includes a second curved surface forming portion that is a part of the second end surface of the tooth main body portion, the second curved surface forming portion including a second curved surface having a depressed shape and that is connected to the front surface of the core back portion or the back surface of the tooth leading end portion.

3. The magnetic core according to claim 1, wherein
the end surface includes a first flat surface parallel to the first direction, and
the first curved surface forming portion projects from the first flat surface in the second direction and is located only on a second direction side relative to the first flat surface.

4. The magnetic core according to claim 1, wherein
the curved surface is a first curved surface,
the tooth main body portion includes a side surface that faces in a circumferential direction with the rotation axis as a center when the magnetic core is incorporated in the rotary electric machine, and
the magnetic core further includes a second curved surface forming portion that is a part of the side surface of the tooth main body portion, the second curved surface forming portion including a second curved surface having a depressed shape and that is connected to the front surface of the core back portion or the back surface of the tooth leading end portion.

5. The magnetic core according to claim 4, wherein
the side surface includes a second flat surface parallel to the first direction, and
the second curved surface forming portion projects from the second flat surface in the circumferential direction and is located only on the circumferential direction side from the second flat surface.

6. The magnetic core according to claim 4, wherein
the tooth main body portion includes an inclined surface connecting the end surface and the side surface, and
a third curved surface forming portion that is a part of the inclined surface of the tooth main body portion, the third curved surface forming portion including a tapered and curved surface that is connected to an edge of the first curved surface of the end surface in the third direction.

7. The magnetic core according to claim 6, wherein
the side surface includes a second flat surface parallel to the first direction, and
the second curved surface forming portion projects from the second flat surface in the circumferential direction and is located only on the circumferential direction side from the second flat surface.

8. The magnetic core according to claim 7, wherein
the end surface includes a first flat surface parallel to the first direction, and
the first curved surface forming portion projects from the first flat surface in the second direction and is located only on a second direction side relative to the first flat surface.

9. The magnetic core according to claim 1, wherein
the tooth main body portion includes a side surface facing in a third direction that is a circumferential direction with the rotation axis as a center when the magnetic core is incorporated in the rotary electric machine, and an inclined surface connecting the end surface and the side surface, and
a third curved surface forming portion that is a part of the inclined surface of the tooth main body portion, the third curved surface forming portion including a tapered and curved surface that is connected to an edge of the curved surface of the end surface in the third direction.

10. The magnetic core according to claim 1, wherein the magnetic core is a molded body comprising a soft magnetic powder.

11. A magnetic core with a coil, comprising:
the magnetic core according to claim 1; and
a coil wound around the tooth main body portion.

12. A rotary electric machine comprising:
the magnetic core according to claim 1.

13. A method for manufacturing a magnetic core, the method comprising:
manufacturing a magnetic core that comprises:
a core back portion including a front surface that faces in a first direction toward a rotation axis of the rotary electric machine when the magnetic core is incorporated in the rotary electric machine;
a tooth portion, wherein the tooth portion includes:
a tooth main body portion extending from the front surface in the first direction, and
a tooth leading end portion at a leading end of the tooth main body portion, wherein
the tooth leading end portion includes a back surface facing in a direction opposite to the first direction,
the tooth main body portion includes an end surface that faces in a second direction along the rotation axis when the magnetic core is incorporated in the rotary electric machine; and
a first curved surface forming portion that is a part of the end surface of the tooth main body portion, the first curved surface forming portion including a curved surface having a depressed shape and that is connected to the front surface of the core back portion or the back surface of the tooth leading end portion; and
finishing the magnetic core through polishing using a spherical medium, wherein
before the finishing of the magnetic core, the magnetic core is manufactured such that a radius of curvature of the curved surface is larger than a radius of the medium used in the finishing of the magnetic core.

14. A method for manufacturing a magnetic core, the method comprising:
manufacturing a magnetic core that comprises:
a core back portion including a front surface that faces in a first direction toward a rotation axis of the rotary electric machine when the magnetic core is incorporated in the rotary electric machine;
a tooth portion, wherein the tooth portion includes:
a tooth main body portion extending from the front surface in the first direction, and
a tooth leading end portion at a leading end of the tooth main body portion, wherein
the tooth leading end portion includes a back surface facing in a direction opposite to the first direction,
the tooth main body portion includes an end surface that faces in a second direction along the rotation axis when the magnetic core is incorporated in the rotary electric machine,
the tooth main body portion includes a side surface that faces in a circumferential direction with the rotation axis as a center when the magnetic core is incorporated in the rotary electric machine;
a first curved surface forming portion that is a part of the end surface of the tooth main body portion, the first curved surface forming portion including a first curved surface having a depressed shape and that is connected to the front surface of the core back portion or the back surface of the tooth leading end portion; and
a second curved surface forming portion that is a part of the of the tooth main body portion, the second curved surface forming portion including a second curved surface having a depressed shape and that is connected to the front surface of the core back portion or the back surface of the tooth leading end portion; and
finishing the magnetic core through polishing using a spherical medium, wherein
before the finishing of the magnetic core, the magnetic core is manufactured such that a radius of curvature of the first curved surface is larger than a radius of the medium used in the finishing of the magnetic core.

15. The method for manufacturing a magnetic core according to claim 14, wherein before the finishing of the magnetic core, the magnetic core is manufactured such that a radius of curvature of the second curved surface is larger than the radius of the medium used in the finishing of the magnetic core.
